(19) United States
(12) Patent Application Publication
(10) Pub. No.: US 2015/0039505 A1
(43) Pub. Date: Feb. 5, 2015

(54) DYNAMIC TRIAL SUBSCRIPTION MANAGEMENT

(71) Applicant: Verizon Patent and Licensing Inc., Basking Ridge, NJ (US)

(72) Inventors: Zhiying Jin, Lexington, MA (US); Ruishuang Wang, Acton, MA (US)

(73) Assignee: Verizon Patent and Licensing Inc., Basking Ridge, NJ (US)

(21) Appl. No.: 13/953,922

(22) Filed: Jul. 30, 2013

(51) Int. Cl. G06Q 20/40

(52) U.S. Cl. CPC G06Q 20/40
USPC 705/44

(57) ABSTRACT

A network device receives a user's selection of a subscription to media content services that includes a designated trial period. The subscription includes access to both digital content and physical media content. The network device receives payment information, for the subscription, that includes a credit card number, a card security code, and a billing address. The network device grants, to a user account, a temporary entitlement for the digital content when the payment information is received and obtains verification of the payment information. The verification includes determining validity of the payment information and verifying that a minimum credit card balance is available on the credit card. The network device selects an updated trial period status from a group of options including terminating the temporary entitlement, extending the temporary entitlement for a first duration, extending the temporary entitlement for a second duration, and issuing credits for the physical media content.

### BACKGROUND

Use of free trials is a marketing technique used to attract customers to products or services. For video subscriptions, free trials may allow a prospective customer to have access to video content for a particular time period (e.g., a day, week, month, etc.) or a particular amount of content (one or more movies). In some instances, it is desirable to have flexibility in a trial subscription program to keep prospective customers, while limiting abuses.

### BRIEF DESCRIPTION OF THE DRAWINGS

FIG. 1 is an exemplary network in which systems and/or methods described herein may be implemented;

FIG. 2 is a block diagram of exemplary components of a device that may correspond to one of the devices of FIG. 1;

FIG. 3 is a block diagram of exemplary functional components of the subscription manager of FIG. 1;

FIGS. 4-6 are block diagrams of exemplary communications among devices in a portion of the network of FIG. 1; and

FIGS. 7 and 8 are flow diagrams of an exemplary process for dynamically managing a trial subscription for a cross-platform content system according to an implementation described herein.

### DETAILED DESCRIPTION OF PREFERRED EMBODIMENTS

The following detailed description refers to the accompanying drawings. The same reference numbers in different drawings may identify the same or similar elements.

Systems and methods described herein may provide for dynamic management of trial subscriptions for video customers of a cross-platform content system that includes access to both digital content (e.g., streaming media or video file downloads) and physical media assets (e.g., DVDs and Blu-ray discs). Generally, customers may initiate a video subscription service by signing up for a free trial subscription for a limited number of days (e.g., 30 days). The free trial subscription may include, for example, a limited duration of digital content entitlements and a limited number of credits for physical assets. Physical assets may be retrieved, for example, at a local kiosk or via home delivery. In one implementation, the free trial subscription may automatically roll over to recurring (e.g., monthly) subscription charges after the trial subscription period expires, unless the subscription is terminated by the customer.

Due to the nature of free trials, customers may attempt to perpetuate free trial subscriptions by various schemes. For example, a user may provide a credit card with an insignificant available balance (e.g., $1.00) to subscribe for a free trial when the user has no intention of becoming a paid subscriber. In other cases, a free trial may be under-utilized by a potential customer, and it may be desirable to extend a trial period for the potential customer to grant additional exposure to the subscription service. Systems and methods described herein provide tools to promote free trials to entice and retain subscription customers after the free trial expires, while limiting abuses of the free trials.

According to one implementation, a network device may receive, from a user device, a selection of a subscription to media content services. The subscription may include both digital content and physical media content and start with a designated trial period. The network device may receive payment information, for the subscription, that includes a credit card number, a card security code, and a billing address. The network device may grant, to a user account, a temporary entitlement for the digital content when the payment information is received and may obtain verification of the payment information. The verification may include determining validity of the payment information and verifying that a minimum credit card balance is available on the credit card. Based on the verification information, the network device may select an updated trial period status from a group of options including terminating the temporary entitlement, extending the temporary entitlement for a first duration, extending the temporary entitlement for a second duration, and issuing the physical media credits.

The term “digital content,” as used herein, refers to content for which distribution is not limited to a particular memory device, such as streaming media and file downloads. In some cases, digital content may be referred to as “electronically delivered content.” The term “physical media asset” (or, in some cases, simply “physical assets”), as used herein, refers to content that is limited for distribution via a particular memory device, such as a DVD or Blu-ray disc. As used herein, the term “digital entitlements” (or, in some cases, simply “entitlements”) refers to access rights for digital content. Conversely, the term “credit,” as used herein, refers an accounting for physical media assets.

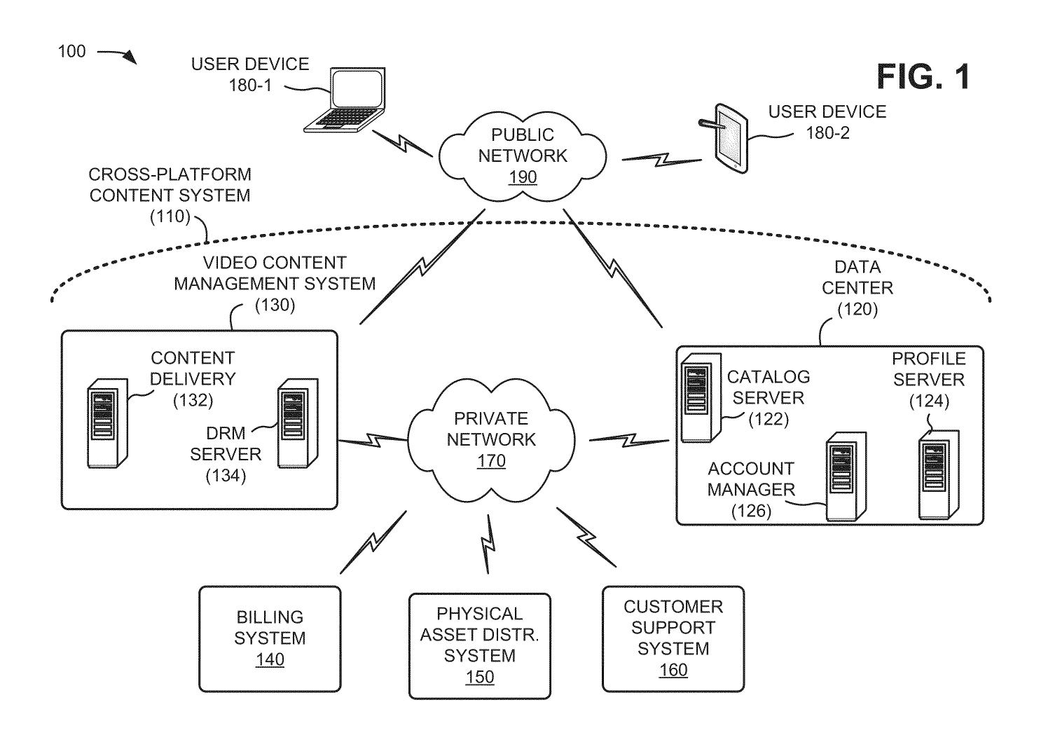

FIG. 1 is an exemplary network 100 in which systems and/or methods described herein may be implemented. As illustrated, network 100 may include a cross-platform content system 110, user devices 180-1 and 180-2 (collectively “user devices 180” and individually “user device 180”) connected by a public network 190. As further shown, cross-platform content system 110 may include a data center 120, a video content management system (VCMS) 130, a billing system 140, a physical asset distribution system 150, a customer support system 160, and a private network 170.

Cross-platform content system 110 may provide, among other services, service subscriptions to access both digital content and physical assets on a periodic basis. For example, the service subscription may be a monthly subscription that includes entitlements to access a particular library of streaming media (e.g., provided from VCMS 130). In one implementation, the library of streaming media may include a subset from a larger collection of content. The service subscription may also include credits which may allow the user to select physical assets from physical asset distribution system 150. The credits may be provided periodically (e.g., monthly) to users' accounts and permit the users to redeem the credits, for example, at local kiosks associated with physical asset distribution system 150.

Data center 120 may manage user authentication, authorization for playing content, selection of content, and/or purchase of content by a user of user devices 180. Data center 120 may provide a backend support system for applications residing on user devices 180. For example, profile server 124 may authenticate (e.g., via account manager 126) a user who desires to purchase, rent, or subscribe to digital or physical content. In another example, data center 120 may permit user device 180 to download a video application that enables a user to find content of interest or play downloaded or streaming content. Once user device 180 is registered at/via data center 120, the downloaded video application may enable user device 180 to present to a user of user device 180 information received from data center 120 in an interactive format, to allow selection of particular digital or physical content. Furthermore, the video application may coordinate with VCMS 130 and data center 120 in authorizing user device 180 to access the selected content, for concurrent viewing sessions or otherwise.

As shown in FIG. 1, data center 120 may include a catalog server 122, a profile server 124, and an account manager 126. In one implementation, the interactions between data center and user device 180 may be performed using hypertext transfer protocol (HTTP) or secure HTTP (HTTPS) via public network 190.

Catalog server 122 may provide a unified catalog of content (e.g., both digital content and physical assets) for user of users devices 180 to consume (e.g., buy, rent, or subscribe). In one implementation, catalog server 122 may collect and/or present listings of content available to user devices 180. For example, catalog server 122 may receive digital content metadata and/or physical asset metadata, such as lists or categories of content, from VCMS 130 and/or physical asset distribution system 150. Catalog server 122 may use the content metadata to provide currently-available content options to user devices 180. Catalog server 122 may provide the content metadata to user device 180 directly or may communicate with user device 180 via another device (e.g., account manager 126).

Profile server 124 may store user profile information for users (e.g., users of user devices 180). The user profile information may include various information regarding a user, such as login information (e.g., a user identifier and a password), billing information, address information, types of services to which the user has subscribed, a list of digital/physical content purchased by the user, a list of video content rented by the user, a list of video content to which the user has subscribed, a user device identifier (e.g., a media player identifier, a mobile device identifier, a set top box identifier, a personal computer identifier) for user device 180, or the like. Account manager 126 may use the user profile information from profile server 130 to authenticate a user and may update the user profile information based on the user's activity.

Account manager 126 may include a network device or computing device that may manage access to services provided by cross-platform content system 110. For example, account manager 126 may initiate accounts for new subscriptions (e.g., a free trial subscription, a paid subscription, etc,) and monitor existing subscriptions. Account manager 126 may receive a login request associated with a user and may initiate a login process. Additionally, or alternatively, account manager 126 may request/receive device information (e.g., a registration token) associated with user device 180 via VCMS 130, and may compare the device information with stored information to validate/authenticate user device 180. Depending on the implementation, the stored information may reside in catalog server 122, profile server 124, account manager 126, etc.

VCMS 130 may aggregate content and content metadata, process content, and distribute content. For example, VCMS 130 may transcode content into a digital format suitable for consumption on particular user devices 180. In some implementations, VCMS 130 may include a transcoder (hardware or software) to convert a video file from one format to another (e.g., from one bit rate to another bit rate, from one resolution to another, from one standard to another, from one file size to another, etc). VCMS 130 may also encrypt data.

As further shown in FIG. 1, VCMS 130 may include a content delivery system 132 and a digital rights management (DRM) server 134. Content delivery system 132 may deliver digital content from a backend server to user devices 180 via, for example, a content delivery network (CDN). In one implementation, content delivery system 132 may include a server that provides streaming data (e.g., via a streaming URL) to user devices 180 (e.g., via public network 190). In one implementation, a streaming URL can be used only once for one user device 180 for security purposes.

DRM server 134 may issue, validate, and/or enforce DRM licenses to a client, such as an application running on one of user devices 180. In some implementations, DRM server 134 may determine entitlement rights and/or other authorization parameters via interfaces of data center 120. Such information may be used to authorize a user to access particular content (e.g., issue a license to user device 180), and control/limit the number of concurrent viewing sessions for the user.

Billing system 140 may manage charging users for services provided via cross-platform content system 110. Billing system 140 may perform credit card checks (e.g., for new subscriptions and/or trial subscriptions) and process payments for subscriptions with cross-platform content system 110. For example, for new accounts, billing system 140 may initiate credit card checks and receive credit card verification from an external billing entity, such as a credit card payment system (e.g., for a credit card account associated with the user) or a bank payment system (e.g., for a debit account associated with the user), associated with the user and/or user device 180, via an external payment API (not shown). For paying (e.g., non-trial) subscribers, billing system 140 may also request and receive payments from the external billing entity (e.g., for monthly subscription fees, etc. associated with an account).

Physical asset distribution system 150 may track physical assets (e.g., DVDs, Blu-ray discs, memory cards, etc.) and provide metadata of physical content for inclusion in catalog information provided to users of user devices 180. In one implementation, physical asset distribution system 150 may also provide physical asset information, such as location information, so that when a user wants to buy/rent a physical asset, the system can direct the user to the nearest location (e.g., a kiosk). Physical asset distribution system 150 may be controlled by a different entity (e.g., a third-party provider or a partner system) than the entity controlling VCMS 130, data center 120, and/or other components of cross-platform content system 110. In implementations described herein, physical asset distribution system 150 may be configured to accept credits (e.g., from a free-trial subscription or a paid subscription) allocated to subscribing customers of cross-platform content system 110. In some implementations, physical asset distribution system 150 may include separate user account information and/or user profiles, such as user contact information, billing information, login credentials (e.g., a user ID and a password), billing history, etc.

Customer support system 160 may solicit and/or receive user feedback, questions, or credit-related requests. In one implementation, customer support system 160 may include interfaces for accessing data center 120 and/or billing system 140, for example, to receive problem reports and to resolve customer billing disputes.

Private network 170 may include, for example, one or more private IP networks that use a private IP address space. Private network 170 may include a local area network (LAN), an intranet, a private wide area network (WAN), etc. In one implementation, private network 170 may implement one or more Virtual Private Networks (VPNs) for providing communication between, for example, any of VCMS 130, data center 120, billing system 140, physical asset distribution system 150, and/or customer support system 160. Private network 170 may be protected/separated from other networks, such as public network 190, by a firewall. Although shown as a single element in FIG. 1, private network 170 may include a number of separate networks.

User device 180 may include a computational or communication device. User device 180 may enable a user to view video content or interact with another user device 180 or a video display device (e.g., a set-top box and/or television). User device 180 may include, for example, a personal communications system (PCS) terminal (e.g., a smartphone that may combine a cellular radiotelephone with data processing and data communications capabilities), a tablet computer, a smartphone, a personal computer, a laptop computer, a gaming console, an Internet television, or other types of computation or communication devices.

In one implementation, user device 180 may include a video application that enables user device 180 to communicate with, for example, data center 120 and/or to present information received from data center 120 to a user. The video application may permit a user of user device 180 to login to an account (e.g., via account manager 126), access catalog information (e.g., from catalog server 122), submit an order (e.g., via catalog server 122), and/or consume live streaming video content (e.g., from VCMS 130).

Public network 190 may include a local area network (LAN), a wide area network (WAN), such as a cellular network, a satellite network, a fiber optic network, a private WAN, the public switched telephone network (PSTN), or a combination of the Internet and a private WAN, etc., that is used to transport data. Although shown as a single element in FIG. 1, public network 190 may include a number of separate networks that function to provide services to user devices 180.

In FIG. 1, the particular arrangement and number of components of network 100 are illustrated for simplicity. In practice there may be more data centers 120, VCMSs 130, billing systems 140, physical asset distribution systems 150, customer support systems 160, user devices 180, and/or networks 170/190. Components of system 100 may be connected via wired and/or wireless links.

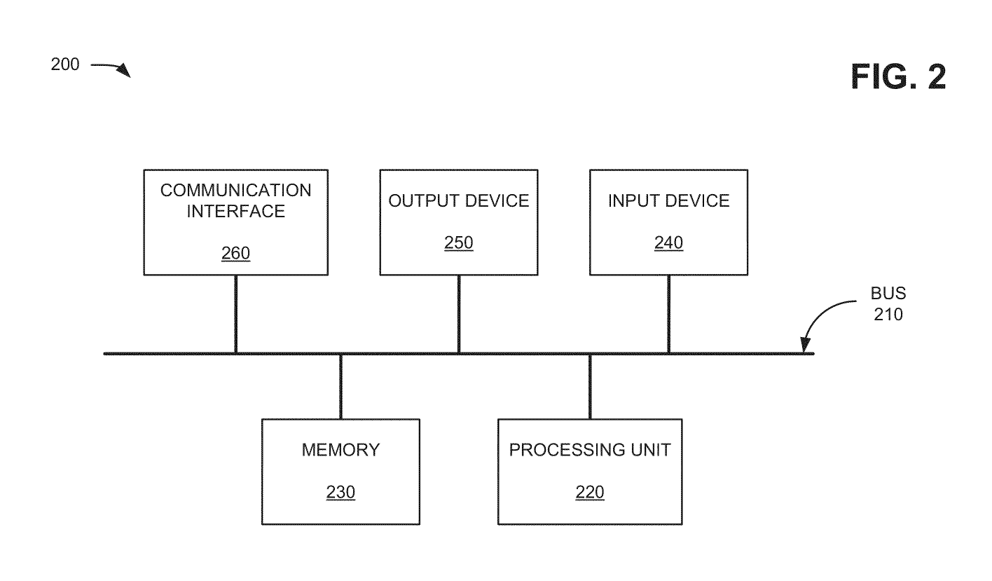

FIG. 2 is a diagram of exemplary components of a device 200. Each of data center 120, catalog server 122, profile server 124, account manager 126, VCMS 130, content delivery system 132, DRM server 134, billing system 140, physical asset distribution system 150, customer support system 160, and user device 180 may be implemented/installed as software, hardware, or a combination of hardware and software, on one or more of device 200. In one implementation, device 200 may be configured as a network device. In another implementation, device 200 may be configured as a computing device. As shown in FIG. 2, device 200 may include a bus 210, a processing unit 220, a memory 230, an input device 240, an output device 250, and a communication interface 260.

Bus 210 may permit communication among the components of device 200. Processing unit 220 may include one or more processors or microprocessors that interpret and execute instructions. In other implementations, processing unit 220 may be implemented as or include one or more application specific integrated circuits (ASICs), field programmable gate arrays (FPGAs), or the like.

Memory 230 may include a random access memory (RAM) or another type of dynamic storage device that stores information and instructions for execution by processing unit 220, a read only memory (ROM) or another type of static storage device that stores static information and instructions for the processing unit 220, and/or some other type of magnetic or optical recording medium and its corresponding drive for storing information and/or instructions.

Input device 240 may include a device that permits an operator to input information to device 200, such as a keyboard, a keypad, a mouse, a pen, a microphone, one or more biometric mechanisms, and the like. Output device 250 may include a device that outputs information to the operator, such as a display, a speaker, etc.

Communication interface 260 may include a transceiver that enables device 200 to communicate with other devices and/or systems. For example, communication interface 260 may include mechanisms for communicating with other devices, such as other devices of system 100.

As described herein, device 200 may perform certain operations in response to processing unit 220 executing software instructions contained in a computer-readable medium, such as memory 230. A computer-readable medium may include a tangible, non-transitory memory device. A memory device may include space within a single physical memory device or spread across multiple physical memory devices. The software instructions may be read into memory 230 from another computer-readable medium or from another device via communication interface 260. The software instructions contained in memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may include fewer components, different components, differently arranged components, or additional components than depicted in FIG. 2. As an example, in some implementations, a display may not be included in device 200. In these situations, device 200 may be a “headless” device that does not include an input device. Alternatively, or additionally, one or more components of device 200 may perform one or more other tasks described as being performed by one or more other components of device 200.

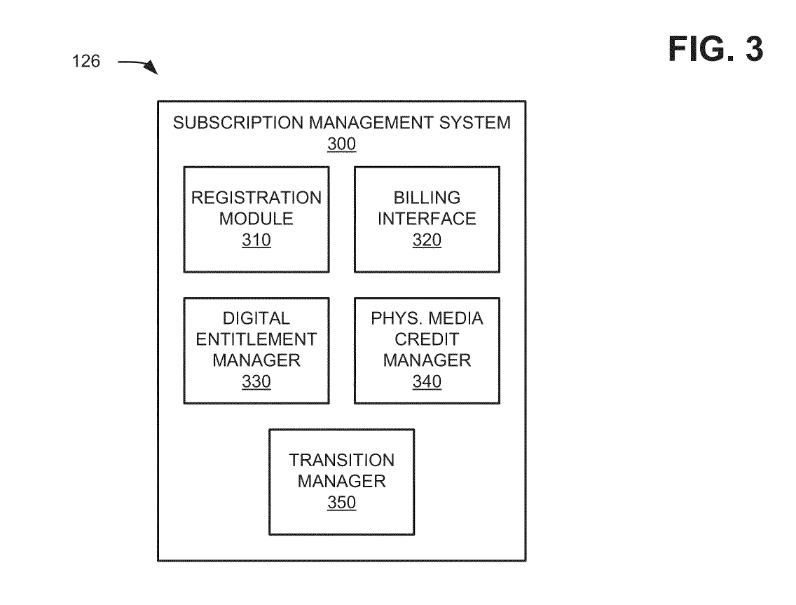

FIG. 3 is a block diagram of exemplary functional components of account manager 126. The functions described in connections with FIG. 3 may be performed by one or more components of device 200 (FIG. 2). As shown in FIG. 3, account manager 126 may include subscription management system 300 that includes a registration module 310, a billing interface 320, a digital entitlement manager 330, a physical media credit manager 340, and a transition manager 350. Generally, subscription management system 300 may dynamically manage trial subscriptions for a cross-platform content system 110 to encourage retention of customers after the trial period expires, while limiting abuses of free trials.

Registration module 310 may register users for a subscription package associated with cross-platform content system 110. For example, registration module 310 may provide a web-based user interface to enable a user of user device 180 to select a free trial subscription package from a group of available subscription packages. Subscription packages may include, for example, a basic package that provides access to titles from a library of streaming media content (e.g., via VCMS 130) and a set monthly amount of credits for DVDs (e.g., from physical asset distribution system 150). Other subscription packages in the group of subscription packages may include premium video-on-demand (VOD) titles (e.g., content beyond the standard library of subscription content) for streaming/downloads and/or credits for Blu-ray discs. In one aspect, a user of user device 180 may select a subscription package that includes a free (or discounted) trial period. Registration module 310 may solicit user credentials (e.g., a client ID and password) and payment information (e.g., a credit card number, billing address, and card security code) from user device 180 to create the selected free trial subscription. In one aspect, registration module 310 may also solicit a customer email address to facilitate off-line notifications (e.g., when a user is not logged in to a web page for cross-platform content system 110, etc.). Upon receipt of the user credentials and payment information, registration module 310 may activate a video subscription for the user by initiating a billing verification, issuing digital entitlements for streaming media according to terms of the subscription, and issuing credits for physical media according to terms of the subscription.

Billing interface 320 may provide payment information from registration module 310 to billing system 140 and may receive credit card verification information from billing system 140. In one aspect, billing interface 320 may initiate a credit card verification based on receiving a free trial subscription indication from registration module 310.

Digital entitlement manager 330 may allocate and track entitlements for digital content for a corresponding user account. For example, based on an indication from registration module 310, digital entitlement manager 330 may allocate an entitlement (e.g., a particular number of movies, a particular amount of time, unlimited access to a particular content library, etc.) corresponding to a selected subscription. For each user account, digital entitlement manager 330 may generally enforce limits of digital content access within the scope of a selected subscription. In one implementation, for example, digital entitlement manager 330 may apply a tracking counter to determine whether the total number of viewing sessions for a user exceeds the maximum number specified in a subscription package for the user. Digital entitlement manager 330 may, for example, provide pending entitlement information for each account (e.g., for use in a user account report, status update, etc.) to profile server 124 or another device in cross-platform content system 110.

Physical media credit manager 340 may allocate and track credits for physical media assets for a corresponding user account. For example, based on an indication from registration module 310, physical media credit manager 340 may allocate credits (e.g., a particular number of DVD rentals, a particular dollar value, etc.) corresponding to a selected subscription. For each user account, digital entitlement manager 330 may generally monitor limits for free access to physical media assets within the scope of a selected subscription. In one aspect, physical media credit manager 340 may communicate with physical asset distribution system 150 to identify updates (e.g., due to additions, expiration, etc.) to credit amounts. In another aspect, physical media credit manager 340 may receive updates (e.g., use of credits at kiosks) to credit amounts from physical asset distribution system 150. Physical media credit manager 340 may, for example, provide pending credit information for each account (e.g., for use in a user account report, status update, etc.) to profile server 124, physical asset distribution system, or another device in cross-platform content system 110.

Transition manager 350 may review trial subscription usage history for individual users and may make decisions to transition from a free trial subscription. For example, transition manager 350 may review a user viewing history from profile server 124 when digital entitlements from the free trial subscription are near expiration. Transition manager 350 may apply criteria from the user viewing history to extend a free trial or transition to recurring billing.

Although FIG. 3 shows exemplary functional components of account manager 126, in other implementations, account manager 126 may include fewer components, different components, or additional components than depicted in FIG. 3. Alternatively, or additionally, one or more functional components of account manager 126 may perform one or more other tasks described as being performed by one or more other functional components of account manager 126.

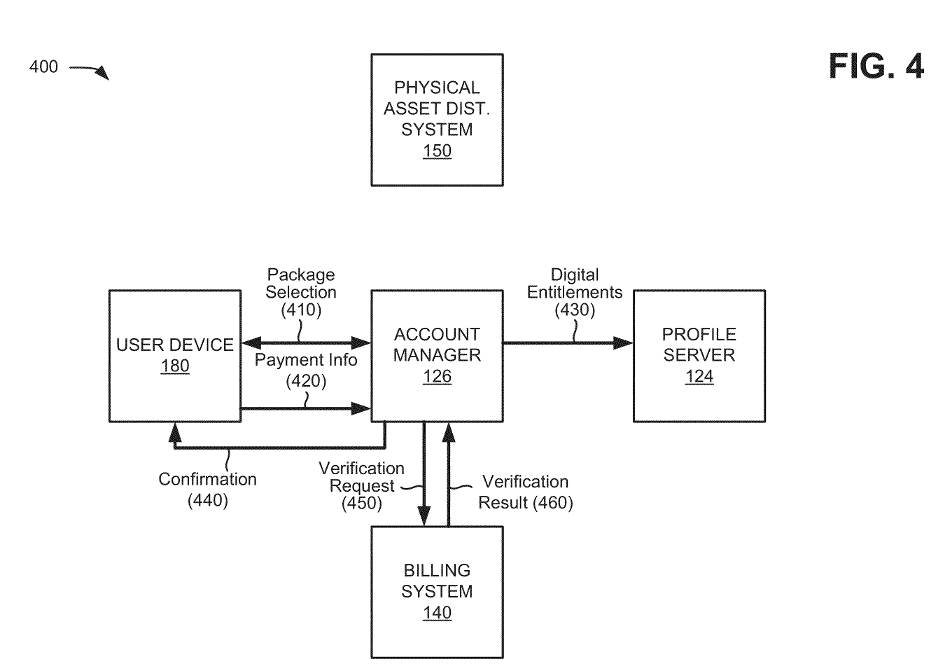

FIGS. 4-6 are diagrams of exemplary communications for a portion 400 of network 100. Communications in FIGS. 4-6 may represent registration procedures for managing a trial subscription to cross-platform content system 110. As shown in FIGS. 4-6, network portion 400 may include profile server 124, account manager 126, billing system 140, physical asset distribution system 150, and user device 180. Profile server 124, account manager 126, billing system 140, physical asset distribution system 150, and user device 180 may include features described above in connection with, for example, FIGS. 1-3.

As shown in FIG. 4, user device 180 may receive options from account manager 126 to select a free trial subscription package, and, based on selection from a user, user device 180 may provide package selection 410 to account manager 126. In one implementation, user device 180 may present a web page (from account manager 126) with different subscription packages for selection. The different subscription packages may include different combinations of digital content entitlements and physical media asset credits (e.g., streaming from basic library with a set amount of DVD credits, basic streaming with Blu-ray credits, or streaming of extended library with DVD/Blu-ray credits) with different recurring charges (e.g., monthly fees). Each of the different subscription packages may begin with a free trial period, after which the recurring charges would be applied, if the selected subscription is not canceled.

Upon receiving package selection 410, account manager 126 may solicit payment information from the user of user device 180 to associated with the selected subscription package. For example, account manager 126 may provide a form (e.g., web page) that user device 180 may present to the user to input payment information. User device 180 may provide the information input by the user as payment information 420. Payment information 420 may include, for example, a user name, a credit card number, a credit card verification code, and a billing address.

Account manager 126 may receive the payment information and activate the selected free trial subscription for the user. For example, account manager 126 may issue temporary digital entitlements for the newly activated subscription. Digital entitlements 430 may be provided, for example, to profile server 124 to associate with a corresponding user account. In one implementation, account manager 126 may provide a confirmation 440 to user device 180 to enable a user to log into the user account and begin accessing digital content. The temporary digital entitlements may be valid for a few hours or days, but are generally not dependent upon a credit check or other background verification process. Thus, temporary digital entitlements may be available to the user almost immediately upon registering for a subscription.

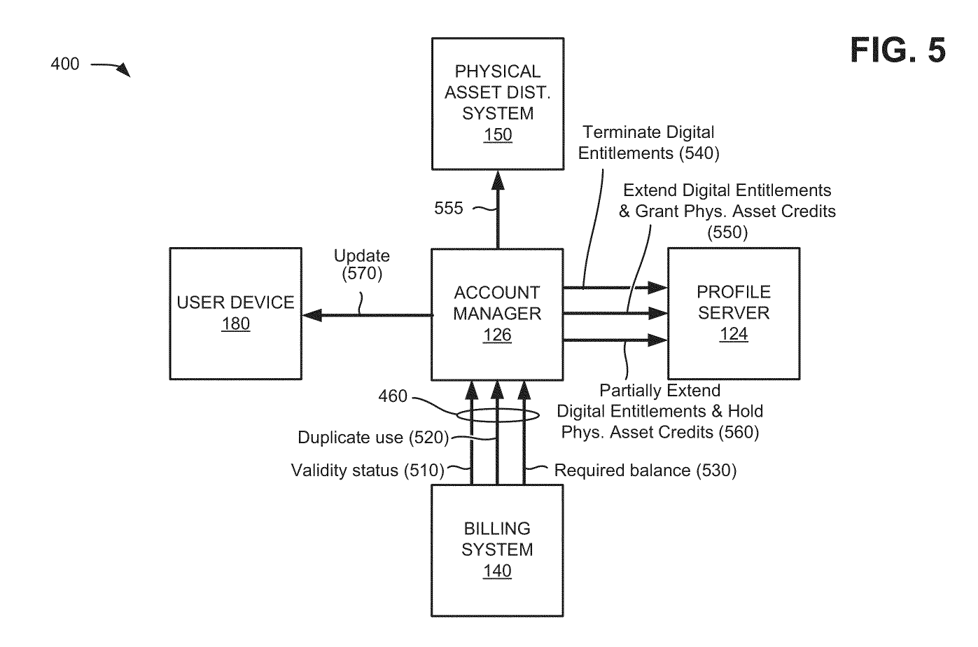

At about the same time, account manager 126 may send a verification request 450 to billing system 140. The verification request may include the payment information and the subscription type (e.g., with the corresponding monthly costs). Verification request 450 may be processed by billing system 140, for example, as a background job. In response to verification request 450, billing system 140 may perform checks to verify the payment information (credit card information) is valid, check for duplicate use of the card for the free trial, and check for a sufficient card balance or limit. Billing system 140 may provide verification results 460 to account manager 126. Verification results 460 are described further in connection with FIG. 5.

Referring to FIG. 5, verification results 460 may include different information which may cause account manager 126 to provide different instructions/updates to one or more of profile server 124, physical asset distribution system 150, and user device 180. Validity status 510 may report if the credit card number, a card security code (a card verification value (CVV), CVV2, or equivalent), and/or billing address for the credit card associated with the subscription are valid. In one implementation, billing system 140 may receive information from other transaction processing systems, such as the address verification system (AVS or equivalent) to determine validity status 510.

Duplicate use check 520 may report if the credit card number associated with the subscription has been previously associated with another free trial subscription. In one implementation, billing system 140 may compare the card number from verification request 450 to a database of previously received credit card numbers (e.g., used for trial subscriptions) to identify duplicate uses of a credit card for a free trial subscription.

Required balance 530 may report whether the credit card number associated with the subscription has a sufficient balance or remaining credit limit, which may be, for example, equal to the monthly subscription fee after the free trial expires. For example, if the monthly subscription fee is five dollars, billing system 140 may submit (to a card transaction service) a pending charge of five dollars.

Account manager 126 may receive validity status 510, duplicate use check 520, and required balance 530 and may dynamically adjust how the subscription order is processed based on the information in validity status 510, duplicate user 520, and/or required balance 530. If validity status 510 indicates, for example, that the credit card associated with the subscription is not valid, then account manager 126 can immediately terminate digital entitlements 540 and provide an update 570 to user device 180 indicating that the digital entitlements have been terminated. Similarly, if duplicate use check 520 indicates that the credit card associated with the subscription has been previously used for a free trial subscription, then account manager 126 can immediately terminate digital entitlements 540 and provide an update 570 to user device 180 indicating that the digital entitlements have been terminated.

Assuming validity status 510 indicates that the credit card associated with the subscription is valid and duplicate use check 520 indicates that the credit card associated with the subscription has not previously been used for a free trial subscription, then account manger 126 may consider information in required balance 530. If required balance 530 indicates, for example, that the credit card associated with the subscription has the required balance (e.g., enough remaining on the credit limit to cover a monthly subscription cost), then account manager 126 can extend the temporary digital entitlements to the full trial period (e.g., 30 days, etc.) and issue a set amount of DVD credits (e.g., in accordance with the subscription terms). More particularly, account manager 126 may notify 550 profile server 124 to extend the duration of digital entitlements associated with the user account and update the allocation of physical media credits. Similarly, account manager 126 may indicate 555 to physical asset distribution system 150 that digital credits have been allocated to the user account. Account manager may also provide update 570 to user device 180 indicating that the digital entitlements and DVD credits have been authorized.

If required balance 530 indicates that the credit card associated with the subscription does not have the required balance, then account manager 126 can extend 560 the temporary digital entitlements to a reduced trial period (e.g., 15 days, etc.) and hold (or not issue) any DVD credits. Account manager 126 may also provide update 570 to user device 180 indicating that the digital entitlements have been partially extended and that DVD credits are on hold pending submission of different payment information or a balance increase.

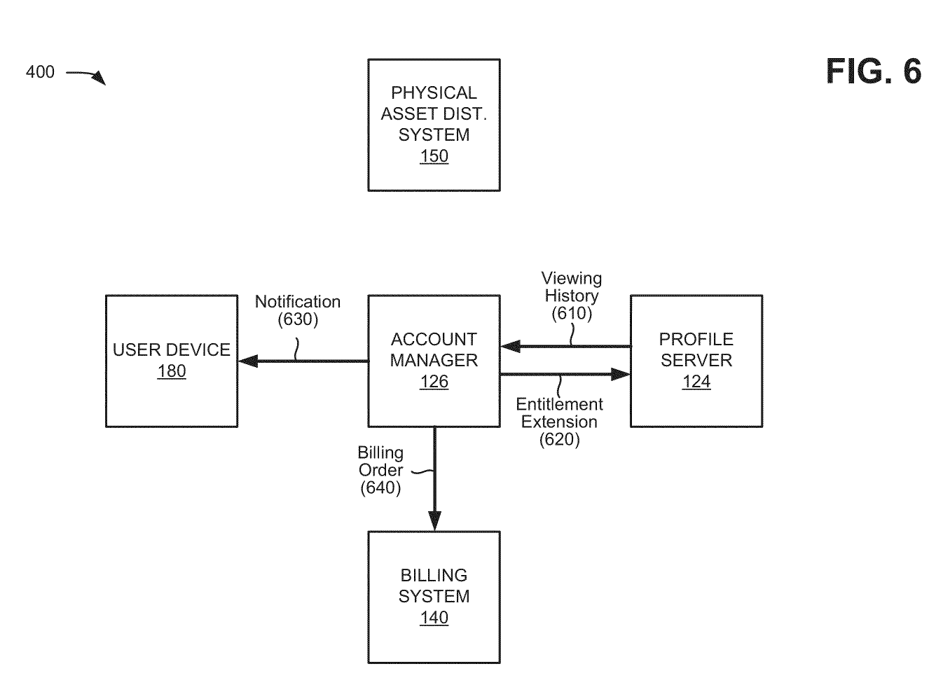

Referring to FIG. 6, account manager 126 may review trial subscription activity when a time period for a free trial subscription is about to expire (e.g., within a few minutes or hours). Account manager 126 may dynamically determine whether to extend or transition from the trial subscription based on the trial subscription activity. In one aspect, account manager 126 may request and review a viewing history 610 for individual trial subscription users. For example, if a user of the trial subscription provided a valid credit card with an acceptable required balance 530, account manager 126 may determine if the user has consumed at least a minimum amount of digital content (e.g., 8 movies, 12 hours, etc.). If the minimum amount of digital content has been consumed, then account manager 126 may simply let the trial subscription expire and transition to recurring billing (unless the subscription is actively canceled by the user). If the minimum amount of digital content has not been consumed, then account manager 126 may extend digital entitlements 620 for an additional period (e.g., 15 days) and notify 630 the user of the extension through, for example, an email account associated with the subscription, a text message, etc.

Depending on the decision to either allow a trial subscription to expire or extend the trial subscription, a billing order 640 may be provided to billing system 140. Billing system 140 may implement recurring billing as a default option upon expiration of a trial subscription or may require express instructions from another system (e.g., account manager 126). In one implementation, billing order 640 may be sent to start recurring billing (e.g., if recurring billing is not a default from the trial subscription) when an extension is not granted. In another implementation, billing order 640 may be sent to delay recurring billing (e.g., if recurring billing is a default from the trial subscription) when an extension is granted.

In another aspect, when a user of the trial subscription provided a valid credit card without the required balance 530, account manager 126 may notify the user when the entitlements are expired that the credit card does not have sufficient funds. In one aspect, account manager 126 may solicit the user of user device 180 to switch to another credit card (e.g., with sufficient funds) and start another free trial period. In another aspect, account manager 126 may notify the user and extend the digital entitlements for the trial subscription (without issuing DVD credits).

Although FIGS. 4-6 show exemplary components of network portion 400, in other implementations, network portion 400 may include fewer components, different components, differently-arranged components, and/or additional components than depicted in FIGS. 4-6. Alternatively, or additionally, one or more components of network portion 400 may perform one or more other tasks described as being performed by one or more other components of network portion 400.

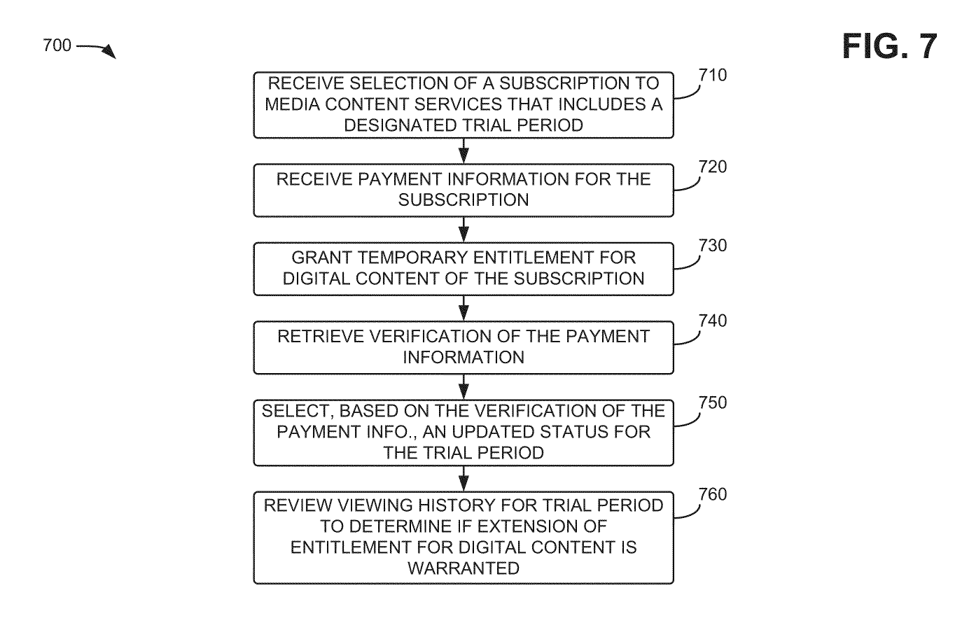

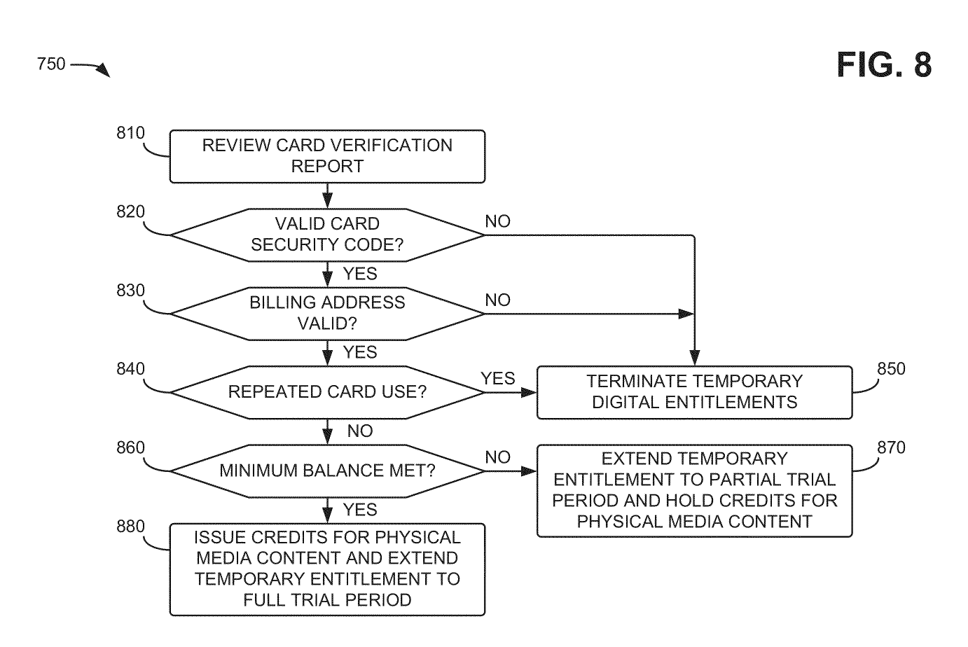

FIGS. 7 and 8 are a flow diagrams of an exemplary process 700 for dynamically managing a trial subscription for a cross-platform content system. In one implementation, process 700 may be performed by account manager 126. In other implementations, process 700 may be performed by account manager 126 and one or more other devices from cross-platform content system 110.

Process 700 may include receiving selection of a subscription, to media content services, that includes a designated trial period (block 710) and receiving payment information from the selected subscription (block 720). For example, as shown in FIG. 4, account manager 126 for cross-platform content system 110 may receive package selection 410 and payment information 420 from user device 180.

Process 700 may also include granting temporary entitlement for the digital content of the subscription (block 730) and retrieving verification of the payment information (block 740). For example, as shown in FIG. 4, account manager 126 may provide digital entitlements 430 to profile server 124 to be available for immediate access by the new subscriber associated with user device 180. Account manager 126 may also send verification request 450 to billing system 140 to the verify payment information.

Process 700 may also include selecting, based on the verification of the payment information, an updated status for the trial period (block 750). For example, as described in connection with FIG. 5, account manager 126 may dynamically adjust how the subscription order is processed based on the information in verification result 460.

Process 700 may further include reviewing viewing history for the trial period to determine if an extension of the entitlement for the digital content is warranted (block 760). For example, as described in connection with FIG. 6, account manager 126 may dynamically determine whether to extend or transition from the trial subscription period based on the trial subscription activity. In one aspect, account manager 126 may request and review a viewing history 610 for an individual trial subscription to determine if the user of the trial subscription provided a valid credit card with an acceptable required balance. In another aspect, when a user of the trial subscription provided a valid credit card without the required balance 530, account manager 126 may notify the user when the entitlements are expired that the credit card does not have sufficient funds.

Process block 750 may include the process block shown in FIG. 8. Referring to FIG. 8, process block 750 may include reviewing a credit card verification report (block 810). For example, account manager 126 may review verification results 460 with validity status 510, duplicate user 520, and/or required balance 530 information.

Process block 750 may include determining if there is a valid card security code (block 820) in the credit card verification report. If there is a valid card security code (block 820—YES), it may be determined if the billing address is valid (block 830). If the billing address is valid (block 830—YES), it may be determined if the credit card has not been used for a previous free trial (block 840). If there is not a valid card security code (block 820—NO), if the billing address is not valid (block 830—NO), or if the credit card has been used for a previous free trial (block 840—YES), then the temporary digital entitlements may be terminated (block 850). For example, as described in connection with FIG. 5, account manager 126 may send message 540 to terminate digital entitlements from profile server 124.

If the credit card has not been used for a previous free trial (block 840—NO), it may be determined if there is an available minimum balance for the credit card (block 860). If there is not an available minimum balance for the credit card (block 860—NO), the temporary entitlement may be extended for a partial duration of the original trial period and credits for physical media content may be held back (block 870). For example, as described in connection with FIG. 5, account manager 126 may send message 560 to partially extend digital entitlements at profile server 124 while holding (or not issuing) physical media asset credits.

If there is an available minimum balance for the credit card (block 860—YES), credits for physical media content may be issued and the temporary entitlement may be extended for the full duration of the original trial period (block 880). For example, as described in connection with FIG. 5, account manager 126 may send message 550 to extend digital entitlements and grant physical media asset credits for the full trial period.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIGS. 7 and 8, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method comprising:
receiving, by a network device and from a user device, a selection of a subscription to media content services that includes a designated trial period, wherein the subscription includes access to both digital content and physical media content;
receiving, by the network device and from the user device, payment information for the subscription and for billing after the trial period, wherein the payment information includes a credit card number, a card security code, and a billing address;
granting, by the network device and to a user account, a temporary entitlement for the digital content when the payment information is received;
obtain, by the network device, verification of the payment information, wherein the verification of the payment information includes:
determining validity of the payment information, and
verifying that a minimum credit card balance is available on the credit card; and
selecting, by the network device and based on obtaining the verification of the payment information, an updated status for the trial period, wherein the updated status is selected from a group of options including terminating the temporary entitlement, extending the temporary entitlement for a first duration, extending the temporary entitlement for a second duration, and issuing credits for the physical media content.

2. The method of claim 1, wherein determining the validity of the payment information includes:
verifying the card security code and the billing address are valid, and
verifying that the credit card number has not been used for a previous trial period.

3. The method of claim 1, further comprising:
issuing, by the network device, credits for the physical media content, and extending the temporary entitlement for the first duration, in response to determining that the verification of the payment information is successful.

4. The method of claim 3, further comprising:
terminating, by the network device, the temporary entitlement when the payment information is determined to be invalid; and
extending, by the network device, the temporary entitlement for the second duration when the payment information is valid and the minimum credit card balance is not available on the credit card.

5. The method of claim 4, further comprising:
providing a notification, to a user associated with the subscription and after the second duration, indicating that the temporary entitlement for the second duration is expired and that the minimum credit card balance is not available on the credit card; and
extending the entitlement for digital content for at least another of the second duration.

6. The method of claim 3, wherein the first duration includes a full length of the designated trial period, and wherein the second duration includes less than the full length of the designated trial period.

7. The method of claim 1, wherein verifying that the minimum credit card balance is available includes posting a pending charge to the credit card.

8. The method of claim 1, further comprising:
monitoring, by the network device, a viewing history associated with the trial period;
transitioning to a recurring payment for the subscription when the viewing history indicates at least a minimum amount of digital content has been consumed; and
extending the entitlement for digital content for at least the second duration when the viewing history indicates at least the minimum amount of digital content has not been consumed.

9. The method of claim 1, wherein issuing the credits for the physical media content includes:
sending, to a physical asset distribution system or a profile server, an indication of the physical media credits associated with the subscription.

10. The method of claim 1, wherein the entitlement enables access to a particular library of content via streaming video or file downloads, and wherein the physical media credits enable retrieval of physical discs from a remote kiosk.

11. A device, comprising:
a network interface to communicate with a remote system;
a memory for storing instructions to be executed by one or more processors; and
the one or more processors configured to execute the instructions to:
receive, from a user device, payment information for a subscription to media content services that includes a designated trial period, wherein the payment information includes at least two of a credit card number, a card security code, or a billing address;
grant, to a user account, a temporary entitlement for a digital content available through the subscription when the payment information is received;
request verification of the payment information, wherein the verification of the payment information includes:
determining validity of the payment information, and
verifying that a minimum credit card balance is available; and
select, based on a response to the requesting of the verification of the payment information, an updated status for the trial period, wherein the updated status is selected from a group of options including terminating the temporary entitlement, extending the temporary entitlement for a first duration, extending the temporary entitlement for a second duration, and issuing credits for physical media available through the subscription.

12. The device of claim 11, wherein the one or more processors are further configured to execute the instructions to:
issue credits for the physical media, and extend the temporary entitlement for the first duration, when the verification of the payment information is successful.

13. The device of claim 12, wherein the one or more processors are further configured to execute the instructions to:
terminate the temporary entitlement when the payment information is determined to be invalid; and
extend the temporary entitlement for the second duration when the payment information not valid and the minimum credit card balance is not available on the credit card.

14. The device of claim 13, wherein the one or more processors are further configured to execute the instructions to:
provide a notification, to a user associated with the subscription and after the second duration, that the temporary entitlement for the second duration is expired and that the minimum credit card balance is not available on the credit card.

15. The device of claim 11, wherein the one or more processors are further configured to execute the instructions to:
monitor a viewing history associated with the trial period;
transition to a recurring payment for the subscription when the viewing history indicates at least a minimum amount of digital content has been consumed; and
extend the entitlement for digital content for at least the second duration when the viewing history indicates at least a minimum amount of digital content has not been consumed.

16. The device of claim 15, wherein, when issuing the physical media credits, the one or more processors are further configured to execute the instructions to:
send, to a physical asset distribution system or a profile server, an indication of the physical media credits associated with the subscription.

17. The device of claim 11, wherein the entitlement enables a user to access a particular library of streaming video or file download content, and wherein the physical media credits allow retrieval of physical discs from a remote kiosk.

18. A non-transitory computer-readable medium, storing instructions executable by one or more processors, the non-transitory computer-readable medium comprising one or more instructions to:
receive, from a user device, a selection of a subscription for media content services that includes a designated trial period, wherein the subscription includes access to both digital content and physical media content;
receive, from the user device, payment information for the subscription, wherein the payment information includes at least two of a credit card number, a card security code, or a billing address;
grant, to a user account, a temporary entitlement for a digital content available through the subscription when the payment information is received;
request verification of the payment information, wherein the verification of the payment information includes:
determining validity of the payment information, and
verifying that a minimum credit card balance is available;
issue credits for the physical media content, and extending the temporary entitlement for a first duration, when the verification of the payment information is successful;
terminate the temporary entitlement when the payment information is determined to be invalid; and
extend the temporary entitlement for a second duration, that is shorter than the first duration, when the payment information is valid and minimum credit card balance is not available on the credit card.

19. The non-transitory computer-readable medium of claim 18, further comprising one or more instructions to:
provide a notification, to a user associated with the subscription and after the second duration, that the temporary entitlement for the second duration is expired and that the minimum credit card balance is not available on the credit card; and
extending the entitlement for digital content for at least another of the second duration.

20. The non-transitory computer-readable medium of claim 18, further comprising one or more instructions to:
monitor a viewing history associated with the trial period;
transition to a recurring payment for the subscription when the viewing history indicates at least a minimum amount of digital content has been consumed; and
extend the entitlement for digital content for at least the second duration when the viewing history indicates at least the minimum amount of digital content has not been consumed.
